(19) United States
(12) Patent Application Publication
(10) Pub. No.: US 2013/0161192 A1
(43) Pub. Date: Jun. 27, 2013

(54) APPARATUS AND METHOD FOR LINEARLY TRANSLOCATING NUCLEIC ACID MOLECULE THROUGH AN APERTURE

(71) Applicants: Jeo-young SHIM, Yongin-si (KR); Dong-ho LEE, Seongnam-si (KR); Tae-han JEON, Hwaseong-si (KR); Seong-ho CHO, Gwacheon-si (KR); Kun-sun EOM, Seoul (KR); Hee-jeong JEONG, Seoul (KR)

(72) Inventors: Jeo-young SHIM, Yongin-si (KR); Dong-ho LEE, Seongnam-si (KR); Tae-han JEON, Hwaseong-si (KR); Seong-ho CHO, Gwacheon-si (KR); Kun-sun EOM, Seoul (KR); Hee-jeong JEONG, Seoul (KR)

(73) Assignee: SAMSUNG ELECTRONICS CO., LTD., Suwon-si (KR)

(21) Appl. No.: 13/572,496

(22) Filed: Aug. 10, 2012

(30) Foreign Application Priority Data
Dec. 23, 2011 (KR) 10-2011-0141723

(51) Int. Cl. C25B 7/00; B82Y 99/00; B82Y 30/00

(52) U.S. Cl. 204/601; 204/627; 204/518; 204/451; 977/962; 977/778

(57) ABSTRACT

An apparatus and method for linearly translocating nucleic acid molecules through an aperture at a reduced rate.

### CROSS-REFERENCE TO RELATED APPLICATIONS

This application claims the benefit of Korean Patent Application No. 10-2011-0141723, filed on December 23, 2011, in the Korean Intellectual Property Office, the disclosure of which is incorporated herein in its entirety by reference.

### BACKGROUND

1. Field

The present disclosure relates to a method and apparatus for linearly translocating nucleic acid molecules through an aperture.

2. Description of the Related Art

Methods of identifying nucleic acids in a rapid, reliable, and inexpensive manner have become increasingly important. A high-throughput apparatus capable of screening and directly reading hybridization, base stacking, and sequences of nucleic acids at a single molecule level can significantly accelerate biological development.

A voltage bias enables single-stranded nucleic acids to translocate through a 1 to 2 nm transmembrane channel of a lipid bilayer. The translocation of nucleic acid strands through the transmembrane channel may be observed by measuring a change in an ionic current of the transmembrane channel. The voltage bias may be used to translocate nucleic acids through biological membranes or pores.

However, a method of controlling a translocation rate of a nucleic acid through a channel has limitations. Therefore, there is a need to develop an apparatus and method for controllably reducing a translocation rate of a nucleic acid through a channel.

### SUMMARY

Provided herein is an apparatus for linearly translocating nucleic acid molecules through an aperture at a reduced rate. The apparatus includes: a first vessel for holding a liquid containing a nucleic acid; a solid substrate comprising an aperture, wherein the aperture comprises an inlet port, an outlet port, and a channel defined between the inlet port and the outlet port and disposed in fluid connection with the first vessel; and a nucleic acid intercalator immobilized on a surface of the solid substrate so as to intercalate into a nucleic acid as it translocates through the aperture.

According to another aspect of the present invention, a method of translocating a nucleic acid through an aperture is provided. The method includes: contacting a liquid containing a nucleic acid with a solid substrate comprising an aperture, wherein the aperture comprises an inlet port, an outlet port, and a channel defined between the inlet port and the outlet port, and wherein a nucleic acid intercalator is immobilized on a surface of the solid substrate so as to intercalate into the nucleic acid; and translocating the nucleic acid through the aperture.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating an apparatus for linearly translocating nucleic acid molecules through an aperture, according to an embodiment of the present invention;

FIG. 2 is an enlarged view of the aperture of the apparatus of FIG. 1, according to an embodiment of the present invention;

FIG. 3 is an enlarged view illustrating a channel of the aperture of the apparatus of FIG. 1, according to an embodiment of the present invention;

FIG. 4 illustrates an interaction between a nucleic acid intercalator and a nucleic acid in the channel of FIG. 3, according to an embodiment of the present invention;

FIG. 5 is a diagram illustrating a process of preparing a solid substrate including an aperture, according to an embodiment of the present invention;

FIGS. 6A and 6B illustrate translocation characteristics of a nucleic acid through an aperture that is not coated with a nucleic acid intercalator, as a control, according to embodiments of the present invention; and

FIGS. 7A, 7B, and 7C illustrate translocation characteristics of a nucleic acid through an aperture that is coated with a nucleic acid intercalator, as an experimental group, according to embodiments of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

According to an embodiment of the present invention, an apparatus for linearly translocating nucleic acid molecules through an aperture includes a first vessel for holding a liquid containing a nucleic acid; and a solid substrate including an aperture, wherein the aperture includes an inlet port, an outlet port, and a channel defined between the inlet port and the outlet port. The channel is fluidly connected with the first vessel, such that the channel is in contact with liquid in the first vessel when in use. A nucleic acid intercalator is immobilized on a surface of the solid substrate so as to be intercalated into the nucleic acid as it passes through the aperture, thereby reducing the rate of passage of the nucleic through the aperture as compared to the rate of passage of the nucleic acid through the aperture in the absence of a nucleic acid intercalator.

The first vessel may be any type of container that can hold a liquid. For example, the first vessel may be a closed chamber including an inlet that adjustably opens and closes, or a container including openings in at least one direction. The nucleic acid may be DNA, RNA, or combinations thereof. Also, the nucleic acid may be in the form of a single strand, a double strand, or combinations thereof. The nucleic acid may have a secondary or tertiary structure. The nucleic acid may be in a separate form from other polymers, not binding thereto.

The solid substrate includes the aperture that includes an inlet port, an outlet port, and a channel defined between the inlet port and the outlet port and that is disposed in contact with the liquid in the first vessel. The channel may include a passage through which a fluid flows, and the passage may be of a closed type or of a gap type with at least one opening. The channel may be connected to the inlet port and the outlet port in a linear or curved path so as to allow fluid flow therebetween.

The solid substrate may be formed of a material derived from a non-living body rather than a material derived from a living body such as a biological membrane. The solid substrate may also be formed of an insulating material. The solid substrate may be silicon nitride (Si₃N₄), aluminum oxide (Al₂O₃), silica (SiO₂), plastic such as Teflon™, an elastomer such as two-component curable silicone rubber, or combinations thereof. The solid substrate may have a face including the inlet port of the aperture and an opposite face including the outlet port. The solid substrate may be of a flat type (e.g., film), a membrane type, or an irregular type. In an embodiment, at least a portion of the solid substrate, which faces the inlet port of the aperture, may be of a flat type. The solid substrate may have a layered structure, for example, a layered structure in which a thin film such as a silicon layer is supported by a support material. The thickness of a portion of the solid substrate, which has the aperture formed therein, may range from about 1 nm to about 1,000 nm, for example, from about 3.4 nm to about 500 nm, for example, from about 1 nm or about 50 nm.

A cross-sectional length (e.g., diameter) of the channel may range from about 1 nm to about 100 nm, for example, from about 1 nm to about 5 nm, from about 1 nm to about 10 nm, from about 5 nm to about 10 nm, for example, from about 1 nm to about 25 nm. A cross-section of the channel may have a circular or polygonal shape. If the cross-section of the channel has a circular shape, the cross-sectional length of the channel is the diameter of the circular shape, and, if the cross-section of the channel has a polygonal shape, the cross-sectional length of the channel is the largest distance of the polygonal shape. The cross-section may be a cross-section obtained by dissecting the channel in a direction perpendicular to the average channel direction (e.g., perpendicular to the direction of the walls of the channel). The cross-sectional length of the channel may be constant with respect to a longitudinal direction of the channel. In other words, the cross-sectional length may be consistent throughout the length of the channel. A longitudinal length of the channel (e.g., the length or distance of the flow path through the channel from the inlet to the outlet) is not particularly limited as long as it allows translocation of a nucleic acid therethrough. The longitudinal length of the channel may be smaller than the length of a nucleic acid to be translocated. The longitudinal length of the channel may be larger than a distance between bases in the nucleic acid molecule, for example, a distance ranging from about 3.4 nm to about 500 nm. The longitudinal length of the channel may be any integer multiple of a distance between bases in the nucleic acid molecule. Further, the longitudinal length of the channel may be smaller than a distance between bases in the nucleic acid molecule, for example, a distance of 3.4 nm or less.

According to the apparatus, a nucleic acid intercalator may be immobilized on the surface of the solid substrate so as to be intercalated into a nucleic acid as it translocates through the aperture, or just prior to entering or exiting the aperture. A position of the nucleic acid intercalator on the surface of the solid substrate is not particularly limited. The intercalator may be immobilized, for example, one at least one of inner surfaces of the channel, which define the channel in the solid substrate. Alternatively, or in addition, the intercalator may be immobilized on a surface of the substrate around an inlet or outlet of the aperture of the solid substrate (e.g., a surface that is adjacent to or surrounds the aperture). In some embodiments, the intercalator is immobilized on a surface of the substrate around the outlet of the aperture at a distance of about 100 μm or less, about 80 μm or less, about 60 μm or less, about 50 μm or less, about 30 μm or less, about 20 μm or less, about 10 μm or less, about 5 μm or less, about 3 μm or less, about 2 μm or less, about 1 μm or less, about 800 nm or less, about 600 nm or less, about 500 nm or less, about 400 nm or less, about 300 nm or less, about 200 nm or less, about 100 nm or less, or about 50 nm or less from the outlet of the aperture.

The nucleic acid intercalator may be electrically neutral. In addition, the nucleic acid intercalator may have a polycyclic aromatic group. The nucleic acid intercalator may have a homocyclic ring or heterocyclic ring. The nucleic acid intercalator may have 10 to 100 carbon atoms. The nucleic acid intercalator may have 2 to 6 benzene rings. Examples of nucleic acid intercalators include naphthalene, anthracene, phenanthrene, pyrene, chrysene, tetracene, acridine, proflavin, daunomycin, doxorubicin, and derivatives thereof.

The nucleic acid intercalator may be immobilized on a surface of the solid substrate by any suitable technique. For example, the immobilization method may be performed by coating the surface of the solid substrate with an amino group-containing material (e.g., γ-aminopropyltriethoxy silane (GAPS)) and reacting an exposed amino group and an activated nucleic acid intercalator having reactivity with an amino group (e.g., 1-pyrenebutyric acid N-hydroxysuccinimide ester). The coating process may be performed by self-assembling. The nucleic acid intercalator may be coated on the surface of the solid substrate at a density ranging from about 0.1 molecules/nm² to about 4 molecules/nm². The nucleic acid intercalator may be immobilized on the surface of the solid substrate via a linker with an appropriate length. The linker is not particularly limited as long as it can space the nucleic acid intercalator apart from the surface of the solid substrate so as for the nucleic acid intercalator to be intercalated between the bases of the nucleic acid. The linker may be non-charged molecules with 1 to 50 carbon atoms. For example, the linker may be —R₁—, —R₁(CO)—, or R₁(CO)O—, where R1 is a C₁-C₅₀ hydrocarbon. The C₁-C₅₀ hydrocarbon may be an aromatic group, alkane, alkene, cycloalkane, alkyne, or combinations thereof. The C₁-C₅₀ hydrocarbon may be, for example, a C₁-C₂₅ hydrocarbon, a C₁-C₂₀ hydrocarbon, a C₁-C₁₀ hydrocarbon, a C₅-C₂₀ hydrocarbon, or a C₅-C₁₀ hydrocarbon.

The apparatus may further include a second vessel for holding a liquid. The second vessel may be disposed such that the liquid contained in the second vessel contacts with a surface opposite to a surface of the solid substrate contacting the liquid contained in the first vessel. In other words, the second vessel may be disposed on the opposite surface of the solid substrate with respect to the first vessel, such that the first vessel is fluidly connected with one end of the channel (e.g., via the inlet or outlet as applicable) and the second vessel is fluidly connected to the opposite end of the channel (e.g., via the inlet or outlet as applicable). The solid substrate may be disposed between the first vessel and the second vessel and define at least a part of the wall of the first vessel and the second vessel. The characteristics of the second vessel except for that may be the same as or different from those of the first vessel.

In an embodiment, the apparatus may further include a member for linearly translocating a nucleic acid through an aperture. The member may be a member for providing a concentration gradient, voltage gradient, magnetic force gradient, and/or a combination thereof between surfaces of the solid substrate in which the inlet port and the outlet port are respectively positioned. The member may include at least two electrodes, one electrode disposed on each side of the solid substrate, i.e., inlet port side and the outlet port side, or within the channel. The electrodes may be part of the aperture or independent of the aperture. If the electrodes are part of the aperture, at least one portion of the channel of the aperture may be formed of a conductive material. For example, at least one portion of the channel of the aperture may be coated with a conductive material or a conductive material may be embedded therein. The member for linearly translocating a nucleic acid through the aperture may be a molecular motor, a mechanical driving device, or combinations thereof that are positioned on at least one side of the substrate, for example, at least one of the inlet port side or the outlet port side, and/or in the channel. The apparatus may further include a power source that is electrically connected to the member. The term “linearly” used herein indicates a longitudinal direction in which a nucleic acid translocates through an aperture.

The apparatus may further include a detector for detecting the nucleic acid that linearly translocates through the aperture disposed on the aperture or a face of the solid substrate. The detector may be an electric detector, an optical detector, or combination thereof. The electric detector may include at least two electrodes. The at least two electrodes may be the same as or different from the above-described electrodes of the member for linearly translocating the nucleic acid through the aperture. The electric detector may be used to measure a current or a voltage. For example, the electric detector may be an ammeter or a voltmeter. The at least two electrodes may be positioned to face the inlet port and the outlet port or positioned in the channel, for example, facing each other. The optical detector may include a light source and a photodetector.

In the apparatus described above, the first vessel itself may be a chamber for amplifying a nucleic acid or the first vessel may be connected to the chamber for amplifying a nucleic acid so as to allow fluid flow therebetween. Also, the first vessel may be connected to a reservoir for storing a reagent or a material so as to allow fluid flow therebetween.

According to another embodiment, a method of translocating a nucleic acid through an aperture includes contacting a liquid containing a nucleic acid with a solid substrate including an aperture that includes an inlet port, an outlet port, and a channel defined between the inlet port and the outlet port, wherein a nucleic acid intercalator is immobilized on a surface of the solid substrate so as to be intercalated into the nucleic acid; and translocating the nucleic acid through the aperture.

The contacting process may be performed by combining or mixing the liquid containing a nucleic acid and the solid substrate. The mixing process may be performed by stirring or without stirring. The liquid containing a nucleic acid may be a sample derived from a living organism or a non-living organism. The sample derived from a living organism may be a liquid sample containing a nucleic acid isolated from a cell, a tissue, blood, serum, urine, body fluid, or combinations thereof. The sample derived from a non-living organism may include a sample containing a synthesized nucleic acid, a semi-synthesized nucleic acid, or an amplified nucleic acid. For example, the sample derived from a non-living organism may be a PCR product. The contacting process may be performed in deionized water or an electrolytic solution. For example, the electrolytic solution may be a solution containing KCl, NaCl, or a combination thereof.

The solid substrate and properties thereof are the same as those described above in the description of the apparatus according to an embodiment of the present invention. In addition, in the contacting and translocating processes, the solid substrate may be positioned in an apparatus according to an embodiment of the present invention for linearly translocating nucleic acid molecules through an aperture.

The method also includes translocating the nucleic acid through the aperture. The translocating process may be performed by a driving force applied to the nucleic acid between the inlet port and the outlet port. For example, the translocating process may be performed by applying to the nucleic acid a driving force such as gravity, diffusion, a voltage gradient, a magnetic force gradient, a molecular motor, a mechanical force, or combinations thereof. For example, a method of applying a voltage gradient between the inlet port and the outlet port may be used. In this case, the inlet port and the outlet port may be in contact with each other in an electrolytic solution. For example, the electrolytic solution may be a solution containing KCl, NaCl, or a combination thereof.

The method may further include detecting the nucleic acid that linearly translocates through the aperture. The detecting of the nucleic acid may include detecting a change in properties while the nucleic acid is linearly translocating through the aperture. The properties may include electrical properties such as current and voltage, optical properties such as absorbance and luminescence, and combinations thereof. For example, the detecting process may include detecting an increase or a decrease in the amount of current, and the amount of time that elapses while the nucleic acid is linearly translocating through the aperture. That is, the detecting process may include measuring a change in electrical or optical properties according to time and detecting the translocation of the nucleic acid based on the measured change. The detecting process may include measuring a change in current in a state where the inlet port and the outlet port are in contact with each other in an electrolytic solution.

In addition, the detection results may be used to determine a base sequence of the nucleic acid. Thus, the method may further include determining the base sequence of the nucleic acid. The determining of the base sequence may be performed by comparing a signal obtained from the nucleic acid with an identified sequence with a detection signal measured while a target nucleic acid with an unidentified sequence is linearly translocating through the aperture.

One or more embodiments of the present invention will now be described more fully with reference to the following examples. However, these examples are provided only for illustrative purposes and are not intended to limit the scope of the present invention.

### Example 1

### Apparatus According to an Embodiment for Linearly Translocating Nucleic Acid Molecules through an Aperture

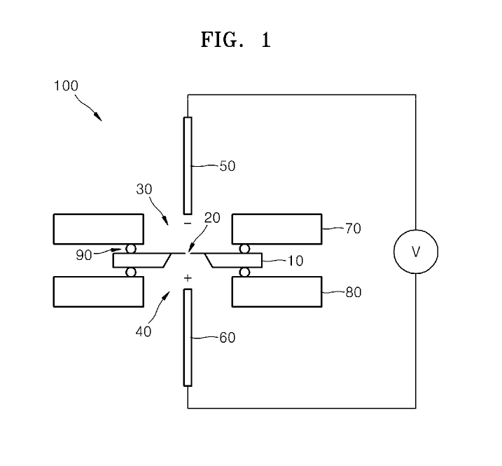

FIG. 1 is a diagram illustrating an apparatus 100 for linearly translocating nucleic acid molecules through an aperture. The apparatus 100 includes a solid substrate 10 including a first vessel 30 for holding a liquid containing a nucleic acid, and an aperture 20. The aperture 20, which may include an inlet port, an outlet port, and a channel defined between the inlet port and the outlet port, is in contact with the liquid in the first vessel 30. A nucleic acid intercalator is immobilized on a surface of the solid substrate 10 so as to be intercalated into the nucleic acid. The aperture 20 of the solid substrate 10 may be formed in a silicon nitride (Si₃N₄) layer. The silicon nitride (Si₃N₄) layer may have, for example, a thickness of about 30 nm.

In addition, the apparatus 100 may include a second vessel 40 for holding a liquid, a member for translocating a nucleic acid through the aperture 20, and/or a pair of electrodes 50 and 60 as an electrical detection member. The first and second vessels 30 and 40 can hold a liquid to prevent exchange of liquid other than through the aperture since they are respectively sealed by an upper plate 70 and a lower plate 80 via a sealing member, for example, O-rings 90.

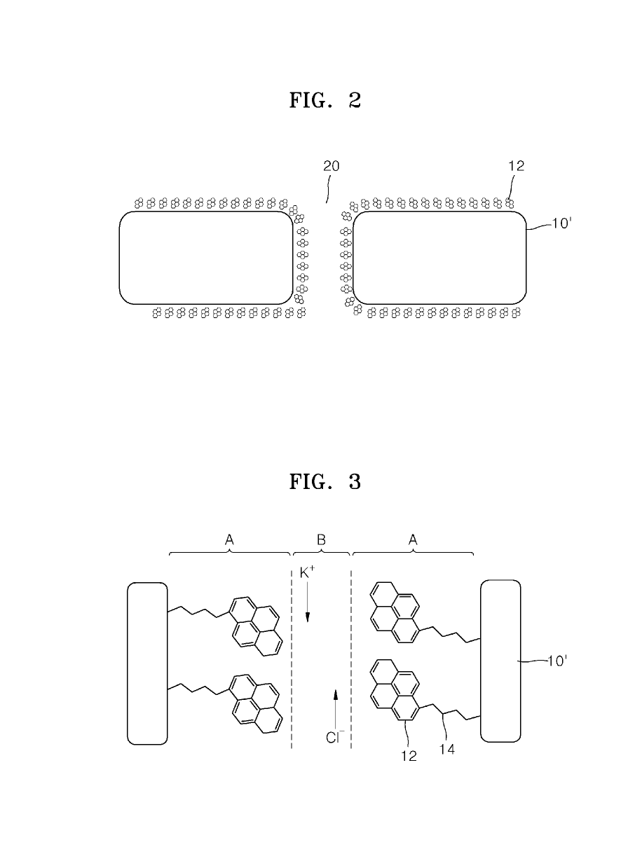

FIG. 2 is an enlarged view of the aperture 20 of the apparatus 100 of FIG. 1, according to an embodiment of the present invention. A portion 10′ including the aperture 20 of the solid substrate 10 is surface-coated with nucleic acid intercalators 12. In FIG. 2, inner surfaces of the channel and surfaces around the inlet port and the outlet port of the aperture 20 are coated with the nucleic acid intercalators 12, but this example is provided only for illustrative purposes. For example, at least one of inner surfaces of the channel and surfaces around the inlet port and the outlet port may be coated with the nucleic acid intercalators 12. The portion 10′ including the aperture 20 of the solid substrate 10 may be formed of the same material as that constituting the remaining portion of the solid substrate 10 or may be a thin-film layer supported by the remaining portion of the solid substrate 10. The portion 10′ including the aperture 20 of the solid substrate 10 may be a thin film, for example, a silicon nitride (Si₃N₄) thin film having a thickness of about 30 nm.

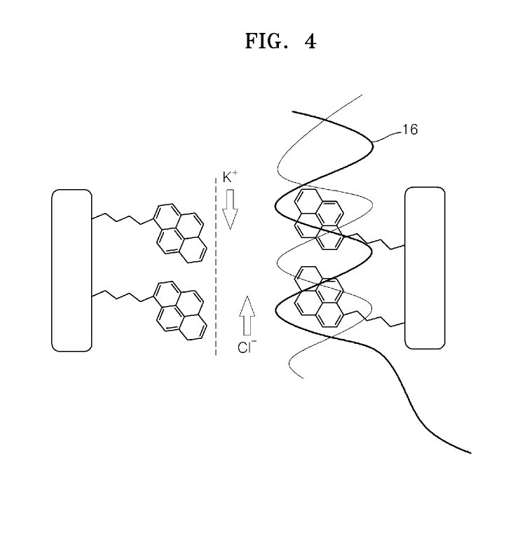

FIG. 3 is an enlarged view illustrating a channel of the aperture 20 of the apparatus 100 of FIG. 1. Referring to FIG. 3, inner surfaces of the channel of the aperture 20 of the portion 10′ are coated with the nucleic acid intercalators 12, for example, pyrenes, via linkers 14. When the channel is filled with an electrolytic solution (e.g., a KCl solution), A regions and a B region are present and indicate hydrophobic regions and a hydrophilic region, respectively. The volumes of the A regions and B region may vary as a nucleic acid translocates through the channel, and a change in electrical properties may be caused, accordingly. The change in electrical properties may be used as a signal for detecting a nucleic acid.

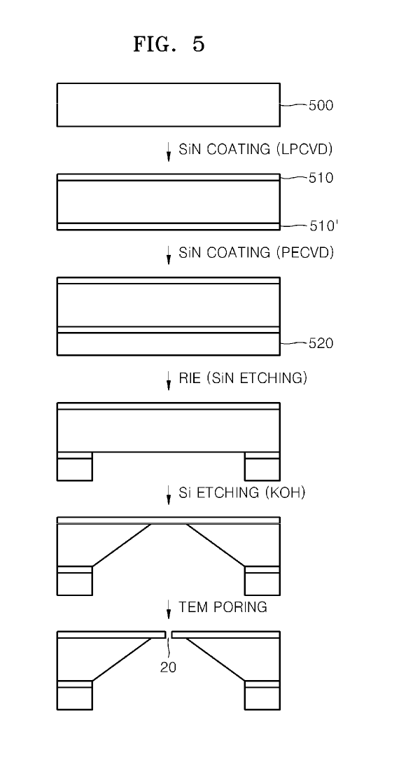

FIG. 4 is a diagram illustrating an interaction between nucleic acid intercalators and a nucleic acid 16 in the channel of FIG. 3. The nucleic acid 16 interacts with nucleic acid intercalators, whereby a translocation rate of the nucleic acid 16 may be reduced.

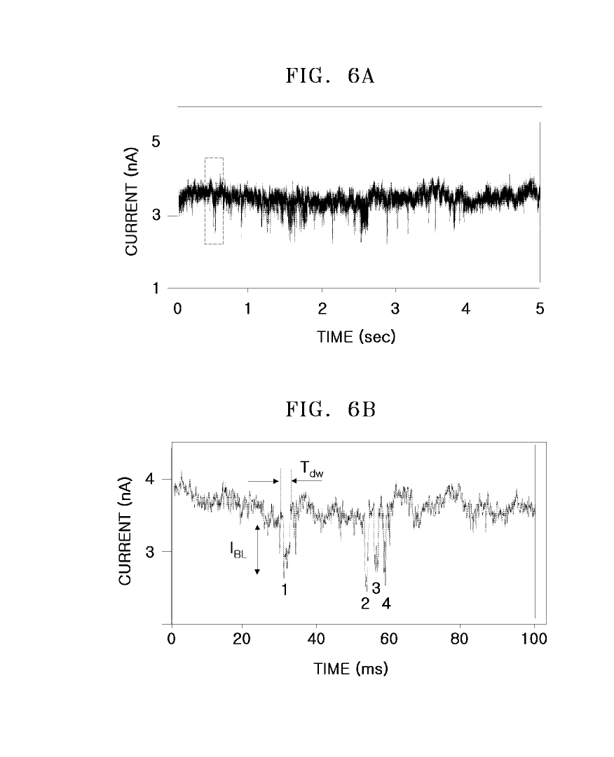

FIG. 5 is a diagram illustrating a process of preparing a solid substrate including an aperture. Referring to FIG. 5, silicon nitride layers 510 and 510′ are respectively coated on a top surface and a bottom surface of a silicon wafer 500 as a starting material by low-pressure chemical vapor deposition (LPCVD). The thicknesses of the silicon wafer 500 and the silicon nitride layers 510 and 510′ may be appropriately adjusted, for example, 300 μm and 30 nm, respectively. The silicon nitride layers 510 and 510′ each act as a thin film in which an aperture is to be formed. Silicon nitride has high dielectric breakdown resistivity and very high DC resistivity. In addition, silicon nitride is mechanically strong, stable at high temperatures, and impermeable to many chemical materials. Furthermore, silicon nitride may be easily wettable by water, and thus, when it contacts with a liquid solution, such as a nucleic acid solution, the occurrence of bubbling in the aperture may be minimized.

Next, a silicon nitride layer 520 is further coated on a bottom surface of the silicon nitride layer 510′ by plasma-enhanced chemical vapor deposition (PECVD). The silicon nitride layer 520 may act as a hard mask for silicon etching. The thickness of the silicon nitride layer 520 may be appropriately adjusted, for example, 300 nm. A photoresist layer is formed on the silicon nitride layer 520 and patterned to form a silicon nitride etching window. The silicon nitride layers 510′ and 520 may be etched using one of various known etching methods, for example, reactive ion etching (RIE). An opposite surface of the silicon wafer 500 may be protected by a blank photoresist layer. Next, the silicon wafer 500 disposed below the silicon nitride etching window may be etched using an appropriate method, for example, a general anisotropic wet etching process using KOH. As a result, an etched profile of the silicon nitride layers 510′ and 520 and the silicon wafer 500 is formed to a pyramid shape. A top surface of the silicon nitride layer 510 may be subjected to transmission electron microscope (TEM) poring, for example, electron beam drilling, to form an aperture.

### Example 2

### Coating of Nucleic Acid Intercalator and Measurement of Translocation Rate of Nucleic Acid

A solid substrate including an aperture was prepared according to the process illustrated in FIG. 5 and an apparatus as illustrated in FIG. 1 was manufactured. The thicknesses of the silicon wafer 500 and the silicon nitride layers 510 and 510′ were 300 μm and 30 nm, respectively. The further coated silicon nitride layer 520 had a thickness of 300 nm. A cross-section of the aperture had a circular shape and a diameter thereof was in the range of about 5 nm to about 10 nm.

(1) Coating of Nucleic Acid Intercalator

A silicon substrate (tetragonal substrate with a size of 1,000 μm×1,000 μm: SiN window with an area of about 30 μm×30 μm) prepared according to the process illustrated in FIG. 5 to have a silicon nitride layer having a thickness of about 30 nm was used, a coupling agent (e.g., GAPS) was attached thereto, and an intercalator was introduced to the silicon substrate.

The silicon substrate was washed before the coupling agent was attached. The washing process was performed using oxygen plasma so as to remove organic impurities on a surface of the silicon substrate. The plasma treatment was performed using PDC-M-01 available from Harrick at 10 W for 5 minutes. A separate drying process was not performed since the process itself is performed in dry conditions.

Immediately after the silicon substrate was washed, the silicon substrate was immersed in a 1%/(v/v) GAPS solution (in ethanol) for 10 minutes. The immersed substrate was washed three times with ethanol and dried in an oven at 70° C. for 40 minutes. All the processes in this experiment were performed in a clean room (class 1000) from which most dust particles were fully removed. As a result, a substrate in which inner surfaces of a channel of the silicon substrate and outer surfaces of the silicon substrate were coated with GAPS and that included an exposed amino group from a surface of the silicon substrate was obtained.

Next, an intercalator was coated on the silanized substrate. Pyrene was used as the intercalator and the coating of the intercalator was performed by immersion. First, 1-pyrenebutyric acid γ-hydroxysuccinimide ester (hereinafter, referred to as “pyrene”) was dissolved in a methylene chloride solution to prepare an immersion solution (0.5 g pyrene/200 ml+0.1 ml triethylamine). The immersion solution and the silicon substrate were put in a reactor and left at room temperature for 5 hours to induce a reaction therebetween. After the reaction was completed, the silicon substrate was taken out from the immersion solution and then washed three times with methylene chloride and three times with ethanol each for 10 minutes.

The washed silicon substrate was dried and the amount of pyrene that reacted with the silicon substrate was measured using a GenePix 4000B fluorescence scanner manufactured by Axon. The scanning process was performed by irradiation of light with a wavelength of 532 nm, and fluorescence intensity at 570 nm was measured by the scanning process. As a result, it was confirmed that a sufficient amount of pyrene was immobilized on the silicon substrate.

(2) Translocation of Nucleic Acid through an Aperture

The solid substrate coated with pyrene that was prepared according to the process (1) above was used to constitute the apparatus 100 illustrated in FIG. 1. In this regard, a jig made of polycarbonate and having a thickness of 10 mm was used as an upper plate and a lower plate. The upper plate and the lower plate were attached to the solid substrate by O-rings to prevent liquid from leaking to the outside. An apparatus including a solid substrate that was coated with pyrene and included an aperture having a diameter of 5.1 nm was used as an experimental group. As a control, an apparatus including a solid substrate that was not coated with pyrene and included an aperture having a diameter of 6 nm was used. In the apparatuses, each of a pair of electrodes was spaced apart from the solid substrate at a distance of 2 mm.

First, a first vessel having a volume of 100 μl and a second vessel having a volume of 100 μl were each filled with 100 μl of a 1M KCl solution in water. A negative (−) voltage was applied to an electrode disposed on the side of the first vessel and a positive (+) voltage was applied to an electrode disposed on the side of the second vessel to generate a voltage gradient between the solid substrate, and the amount of current flowing through a nanoaperture was measured and a noise level was measured. In addition, whether the apparatuses normally operated was confirmed through the noise level. A 100 μl solution of lambda DNA (double-stranded DNA having a length of 48.5 kb) in water (5 ng/μl) was added to the first vessel. Afterwards, a negative (−) voltage was applied to the electrode disposed on the side of the first vessel and a positive (+) voltage was applied to the electrode disposed on the side of the second vessel to generate a voltage gradient between the solid substrate, thereby allowing a nucleic acid to translocate through the aperture. In the experimental group and control, 250 mV and 200 mV were respectively applied. The translocation of the nucleic acid was confirmed measuring a change in current according to time through the same electrode.

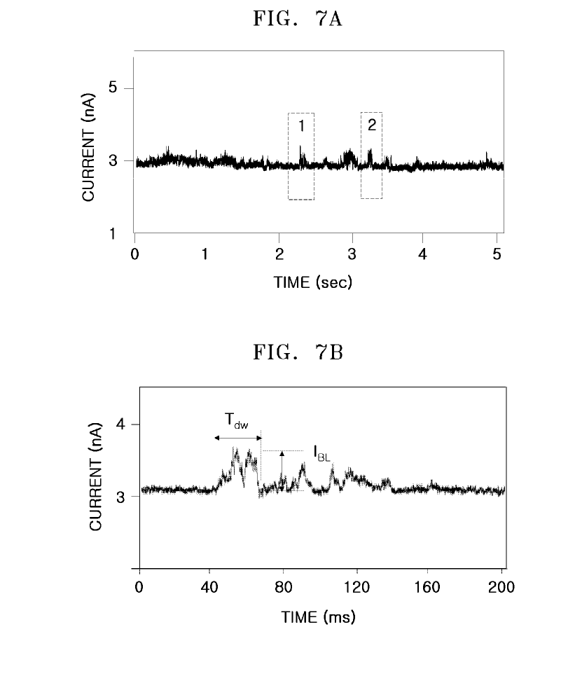

FIGS. 6A and 6B illustrate translocation characteristics of a nucleic acid through an aperture that is not coated with a nucleic acid intercalator, as a control. FIG. 6A is a graph showing a change in current according to translocation of a nucleic acid, and FIG. 6B is an enlarged view of a box region illustrated in FIG. 6A. In FIG. 6B, T_{dw} denotes a dwell time and I_{BL} denotes a blockade current. In FIGS. 6A and 6B, the diameter of the aperture used was 6 nm and the applied voltage was 200 mV.

TABLE 1

| Peak | T_{dw} (ms) | I_{BL}(pA) |
|---|---|---|
| 1 | 22 | 670 |
| 2 | 14 | 880 |
| 3 | 15 | 640 |
| 4 | 0.9 | 750 |

Table 1 shows a dwell time and a blockade current of each peak. A translocation time was 2 ms. Thus, a base translocation rate per unit time is 2.4×10⁷ bp/s (48.5 kbp/2 ms) (i.e., 48.5 kbp/2 ms=2.4×10⁴ bp/ms=2.4×10⁷ bp/s).

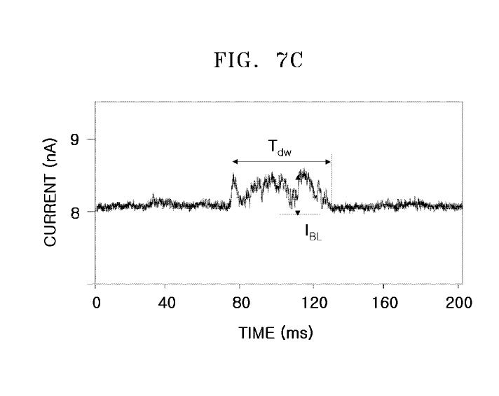

FIGS. 7A, 7B, and 7C illustrate translocation characteristics of a nucleic acid through an aperture that is coated with a nucleic acid intercalator, as an experimental group. FIG. 7A is a graph showing a change in current according to translocation of a nucleic acid and FIGS. 7B and C are enlarged views of box regions 1 and 2 illustrated in FIG. 7A. In FIGS. 7B and 7C, T_{dw} denotes a dwell time and I_{BL} denotes a blockade current. In FIGS. 7A through 7C, the diameter of the aperture used was 5.1 nm and the applied voltage was 250 mV.

TABLE 2

| Peak | T_{dw} (ms) | I_{BL} (pA) |
|---|---|---|
| 1 | 27 | 400 |
| 2 | 58 | 350 |

Table 2 shows a dwell time and a blockade current of each peak. A translocation time was 50 ms. Thus, a base translocation rate per unit time is 9.7×10⁵ bp/s. From the results shown in Table 2, it was confirmed that a translocation rate of a nucleic acid could be significantly reduced by coating a surface of the aperture with a nucleic acid intercalator. This indicates that the translocation rate of a nucleic acid may be controlled by coating the surface of the aperture with a nucleic acid intercalator. In addition, as shown in FIG. 7, a current change direction according to the translocation of the nucleic acid was opposite to that in the control by coating the surface of the aperture with the nucleic acid intercalator. That is, a blockade current according to the translocation of the nucleic acid was reduced in the control, while the blockade current was increased in the experimental group. The increase in blockade current in the experimental group is attributed to migration of ions in an electrolytic solution is inhibited by hydrophobicity of pyrene before DNA translocates, and when DNA translocates through a channel by interaction between DNA and the nucleic acid intercalator, a current is increased by channeling effects. In other words, this is considered because migration of ions is increased by the interaction between DNA and the nucleic acid intercalator.

According to an apparatus according to an embodiment of the present invention, a translocation rate of a nucleic acid may be controlled. In addition, a buffer used in the translocation of a nucleic acid has fewer limitations. For example, a nucleic acid intercalator may interact with DNA in distilled water or a buffer with a low concentration. In addition, a product of nucleic acid amplification, for example, PCR amplification, may itself be translocated without separate isolation of nucleic acids. That is, there is no need to remove protein used in nucleic acid amplification.

As described above, according to the one or more of the above embodiments of the present invention, a nucleic acid may be linearly translocated through an aperture at a reduced rate by using an apparatus for linearly translocating nucleic acid molecules through an aperture. Therefore, the apparatus may be used to analyze the sequence of nucleic acids or isolate nucleic acids.

In addition, a nucleic acid may be linearly translocated through an aperture at a reduced rate by using a method of translocating a nucleic acid through an aperture. Therefore, the method may be used to analyze the sequence of nucleic acids or isolate nucleic acids.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for linearly translocating nucleic acid molecules through an aperture, the apparatus comprising:
a first vessel for holding a liquid containing a nucleic acid;
a solid substrate comprising an aperture, wherein the aperture comprises an inlet port, an outlet port, and a channel defined between the inlet port and the outlet port and in fluid connection with the first vessel:
a nucleic acid intercalator immobilized on a surface of the solid substrate configured to intercalate into a nucleic acid translocating through the aperture.

2. The apparatus of claim 1, wherein the channel has a cross-sectional length ranging from about 1 nm to about 100 nm.

3. The apparatus of claim 1, wherein the nucleic acid intercalator is immobilized on one or more inner surfaces that define the interior of the channel, a surface around the inlet of the aperture of the solid substrate, or both.

4. The apparatus of claim 3, wherein the nucleic acid intercalator is immobilized on a surface of the substrate and positioned about 100 μm or less from the inlet of the aperture.

5. The apparatus of claim 1, wherein the nucleic acid intercalator is electrically neutral and has a polycyclic aromatic group.

6. The apparatus of claim 5, wherein the nucleic acid intercalator has two to six benzene rings.

7. The apparatus of claim 6, wherein the nucleic acid intercalator is naphthalene, anthracene, phenanthrene, pyrene, chrysene, tetracene, acridine, proflavin, daunomycin, doxorubicin, or a derivative thereof.

8. The apparatus of claim 1, further comprising a second vessel for holding a liquid, wherein the first vessel is in fluid connection with the channel via the inlet, and the second vessel is in fluid connection with the channel via the outlet.

9. The apparatus of claim 1, further comprising a member for linearly translocating the nucleic acid through the aperture.

10. The apparatus of claim 1, further comprising a detector disposed within the aperture or on a face of the substrate for detecting a nucleic acid that linearly translocates through the aperture.

11. A method of translocating a nucleic acid through an aperture, the method comprising:
contacting a liquid containing a nucleic acid with a solid substrate, the solid substrate comprising an aperture having an inlet port, an outlet port, and a channel defined between the inlet port and the outlet port, and comprising a nucleic acid intercalator immobilized on a surface of the solid substrate for intercalating into the nucleic acid; and
translocating the nucleic acid through the aperture.

12. The method of claim 11, wherein the channel has a cross-sectional length ranging from about 1 nm to about 100 nm.

13. The method of claim 11, wherein the nucleic acid intercalator is immobilized on one or more inner surfaces that define the interior of the channel, a surfaces around the inlet of the aperture of the solid substrate, or both.

14. The method of claim 13, wherein the nucleic acid intercalator is immobilized on a surface of the substrate and positioned about 100 μm or less from the inlet of the aperture.

15. The method of claim 11, wherein the nucleic acid intercalator is electrically neutral and has a polycyclic aromatic group.

16. The method of claim 15, wherein the nucleic acid intercalator has two to six benzene rings.

17. The method of claim 16, wherein the nucleic acid intercalator is naphthalene, anthracene, phenanthrene, pyrene, chrysene, tetracene, acridine, proflavin, daunomycin, doxorubicin, or a derivative thereof.

18. The method of claim 11, wherein the translocating is performed using diffusion, a voltage gradient, a magnetic force gradient, a molecular motor, a mechanical force, or a combination thereof.

19. The method of claim 11, further comprising detecting a nucleic acid that linearly translocates through the aperture.

20. The method of claim 19, wherein the detecting comprises applying an electrical current across the aperture and measuring a change in the current.
